(19) United States
(12) Patent Application Publication
(10) Pub. No.: US 2016/0004367 A1
(43) Pub. Date: Jan. 7, 2016

(54) DISPLAY APPARATUS FOR VEHICLE

(71) Applicant: HONDA MOTOR CO., LTD., Tokyo (JP)

(72) Inventor: Masahiko Shimada, Wako-shi (JP)

(73) Assignee: HONDA MOTOR CO., LTD., Tokyo (JP)

(21) Appl. No.: 14/789,397

(22) Filed: Jul. 1, 2015

(30) Foreign Application Priority Data
Jul. 4, 2014 (JP) 2014-138997

(51) Int. Cl. G06F 3/047; G09G 5/00; G06F 3/044

(52) U.S. Cl. CPC G06F 3/047; G06F 3/044; G09G 5/003; G09G 2300/0426

(57) ABSTRACT

A vehicle display apparatus includes a ring dial rotatable about an axis perpendicular to a surface of a steering wheel, a first rotation angle detector configured to detect rotation of the ring dial, a capacitive electrode disposed radially outside the ring dial so as to surround the ring dial and configured to detect at least a user's touch, and a display panel configured to cause transition of a screen in response to detection of rotation of the ring dial by the first rotation angle detector and detection of the user's touch by the capacitive electrode.

### CROSS REFERENCES TO RELATED APPLICATIONS

The present application claims priority under 35 U.S.C. §119 to Japanese Patent Application No. 2014-138997, filed Jul. 4, 2014, entitled “Display Apparatus for Vehicle.” The contents of this application are incorporated herein by reference in their entirety.

### BACKGROUND

1. Field

The present disclosure relates to a display apparatus for a vehicle (hereinafter, referred to as a “vehicle display apparatus”).

2. Description of the Related Art

Vehicle display apparatuses known in the art are configured to display a desired menu to be selected from a plurality of hierarchically leveled menus relating to operations of in-vehicle devices. Techniques for incorporating such a vehicle display apparatus into a steering wheel have been disclosed (refer to Japanese Unexamined Patent Application Publication No. 2012-22393 and International Publication No. WO 2013/179390, for example).

Allowing the vehicle display apparatus to have a plurality of functions in order to increase ease of operation of this apparatus leads to an increase in size of the apparatus. The steering wheel accordingly has to have a space enough to install the vehicle display apparatus, resulting in a reduction in design quality.

### SUMMARY

The present application has been made in consideration of the above-described disadvantages in the art. The present application describes a vehicle display apparatus having a plurality of functions arranged in compact form, and thus providing ease of operation and having a small size.

A first aspect of the present application provides a vehicle display apparatus including a ring-shaped member (e.g., a ring dial 9 in an embodiment) rotatable about an axis (e.g., an axis L1 in the embodiment) perpendicular to an installation surface (e.g., a surface 4a of a steering wheel 3 in the embodiment) in which the ring-shaped member is disposed, a rotation detecting unit (e.g., a detector such as a first rotation angle detector 13 in the embodiment) configured to detect rotation of the ring-shaped member, a touch detecting unit (e.g., a detector such as a capacitive electrode 10 in the embodiment) disposed radially outside the ring-shaped member so as to surround the ring-shaped member and configured to detect at least a user's touch, and a display unit (e.g., a display panel 6 in the embodiment) configured to cause transition of a screen (e.g., a screen G in the embodiment) in response to detection of rotation of the ring-shaped member by the rotation detecting unit and detection of the user's touch by the touch detecting unit.

Such a configuration allows the vehicle display apparatus to have a plurality of functions arranged in compact form and also allows a space to be provided radially inside the ring-shaped member. This space is effectively used to provide an additional desired function. This configuration accordingly enables the vehicle display apparatus to have a plurality of functions arranged in compact form, and thus provide ease of operation and have a small size.

In this aspect, the installation surface may be a surface of a steering wheel (for example, the surface 4a of the steering wheel 3 in the embodiment) or a surface of a center console (for example, a surface 31a of a center console 31 in the embodiment).

Such a configuration enables the vehicle display apparatus to be user-friendly because a user (driver) can readily operate the vehicle display apparatus without moving his or her hand to the apparatus.

In the aspect, the ring-shaped member may have a sloping surface (e.g., a sloping surface 9b in the embodiment) formed by chamfering an outer circumferential edge of the ring-shaped member.

Such a configuration enables smooth or step-free arrangement of the sloping surface and the installation surface. This can reduce uncomfortable feeling of the user caused upon touching the ring-shaped member and the installation surface at the same time.

In the aspect, the touch detecting unit may detect only the user's touch.

Such a configuration enables the touch detecting unit to have a simplified configuration, leading to a reduction in manufacturing cost of the vehicle display apparatus.

In the aspect, the display unit may display a plurality of hierarchy levels and a plurality of menus included in the hierarchy levels. The touch detecting unit may include a capacitive electrode to detect a user's touch. The capacitive electrode may include a plurality of capacitive electrode segments corresponding to the hierarchy levels.

Such a configuration enables the vehicle display apparatus to have a simple configuration and a small size, and provide ease of use.

In the aspect, the installation surface may include covering portions (e.g., covering portions 12 in the embodiment) that partly cover the touch detecting unit to partition the touch detecting unit into parts corresponding to the capacitive electrode segments.

Such a configuration enables the user to reliably make an effect on the touch detecting unit for each hierarchy level, thus preventing a wrong operation by the user.

### BRIEF DESCRIPTION OF THE DRAWINGS

FIG. 1 is a schematic diagram illustrating the configuration of the interior of a vehicle provided with a vehicle display apparatus according to an embodiment.

FIG. 2 is a diagram explaining an exemplary manner of displaying on a screen in the embodiment.

FIG. 3 is a schematic diagram illustrating the configuration of a display apparatus body in the embodiment.

FIG. 4 is a cross-sectional view illustrating the display apparatus body taken along a line IV-IV in FIG. 3.

FIG. 5 is a cross-sectional view illustrating the display apparatus body taken along a line V-V in FIG. 3.

FIG. 6 is a diagram explaining a way of operating an uppermost level display area in the vehicle display apparatus according to the embodiment.

FIG. 7 is a diagram explaining a way of operating an intermediate level display area in the vehicle display apparatus according to the embodiment.

FIG. 8 is a diagram explaining a way of operating a lowermost level display area in the vehicle display apparatus according to the embodiment.

FIG. 9 is a cross-sectional view illustrating a display apparatus body in a first modification of the embodiment.

FIG. 10 is a cross-sectional view illustrating a display apparatus body in a second modification of the embodiment.

### DESCRIPTION OF THE PREFERRED EMBODIMENTS

An embodiment will be described with reference to the drawings.

### Vehicle Display Apparatus

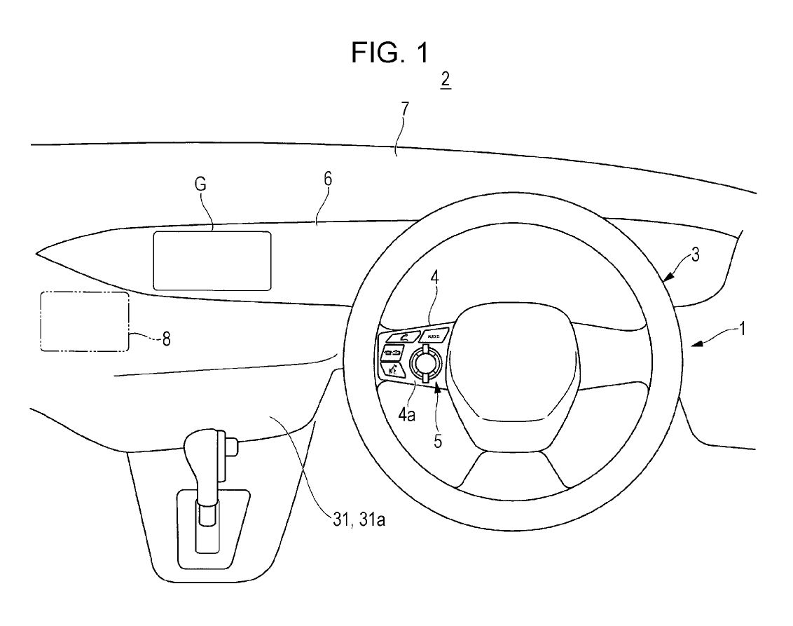

FIG. 1 is a schematic diagram illustrating an interior 2 of a vehicle provided with a vehicle display apparatus 1 according to the embodiment.

In the following description, a direction (lateral direction in FIG. 1) from side to side of the vehicle in the interior 2 will be simply referred to as a “lateral direction” and a direction (vertical direction in FIG. 1) along the direction of gravity will be simply referred to as a “vertical direction”.

Referring to FIG. 1, the vehicle display apparatus 1 includes a display apparatus body 5 disposed on a surface 4a of a spoke 4 of a steering wheel 3 and a display panel 6 for displaying a result of operation on the display apparatus body 5.

The display panel 6 is disposed in an instrument panel 7. A screen G displayed on the display panel 6 is controlled by a display electronic control unit (ECU) 8. The display ECU 8 receives a signal output from the display apparatus body 5.

The display ECU 8 is disposed in an engine room, for example. In the embodiment, the display ECU 8 is indicated by a chain double-dashed line in FIG. 1 for convenience of explanation.

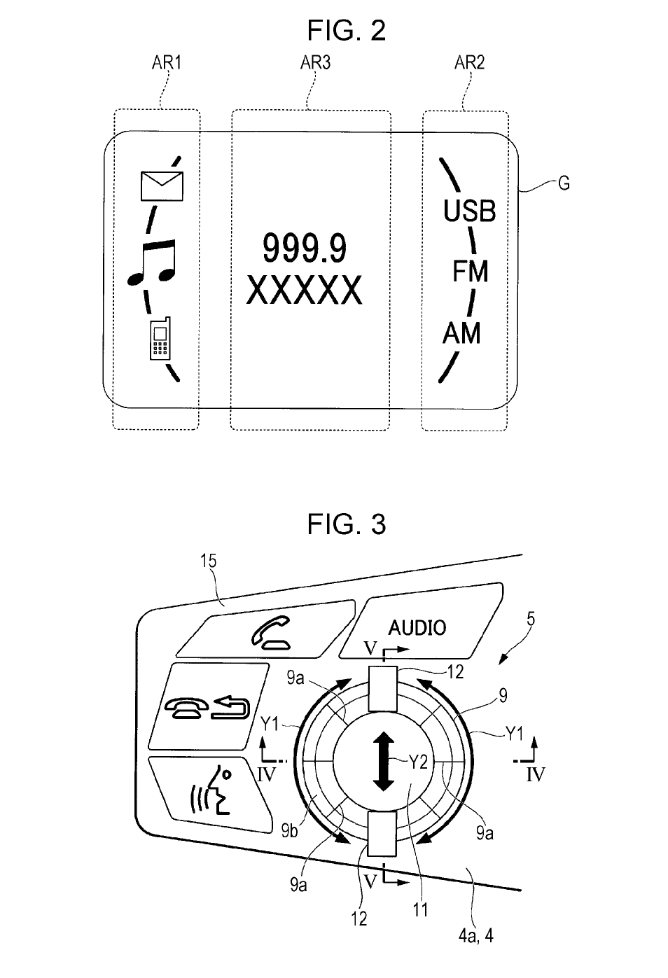

An exemplary manner of displaying on the screen G will now be described with reference to FIG. 2.

FIG. 2 is a diagram explaining the exemplary manner of displaying on the screen G. Although various methods of setting the manner of displaying on the screen G and display items can be used, the manner of displaying as illustrated in FIG. 2 will be described as an example. The manner of displaying on the screen G and the display items are not limited to those in FIG. 2, but can be variously set depending on specifications. The following description will be based on the manner of displaying illustrated in FIG. 2.

Referring to FIG. 2, the screen G displays hierarchically leveled menus. Specifically, the screen G has an uppermost level display area AR1 on the left, an intermediate level display area AR2 on the right, and a lowermost level display area AR3 in the middle of the screen G in the lateral direction.

The uppermost level display area AR1 of the screen G displays a menu providing menu items, for example, a function for listening to music or radio broadcasting, a mail function, and an address book function.

The intermediate level display area AR2 of the screen G displays a lower level menu than a menu item selected in the uppermost level display area AR1. For example, if the menu item for listening to music is selected in the uppermost level display area AR1, a menu providing, for example, radio broadcasting (e.g., FM broadcasting and AM broadcasting) and an USB port is displayed in the intermediate level display area AR2. For example, if the USB port is selected, a user can listen to a music piece stored in a portable terminal connected to the USB port.

The lowermost level display area AR3 of the screen G displays a lower level menu than a menu item selected in the intermediate level display area AR2. For example, if radio broadcasting (FM broadcasting) is selected in the intermediate level display area AR2, a broadcasting station (frequency) is displayed.

### Display Apparatus Body

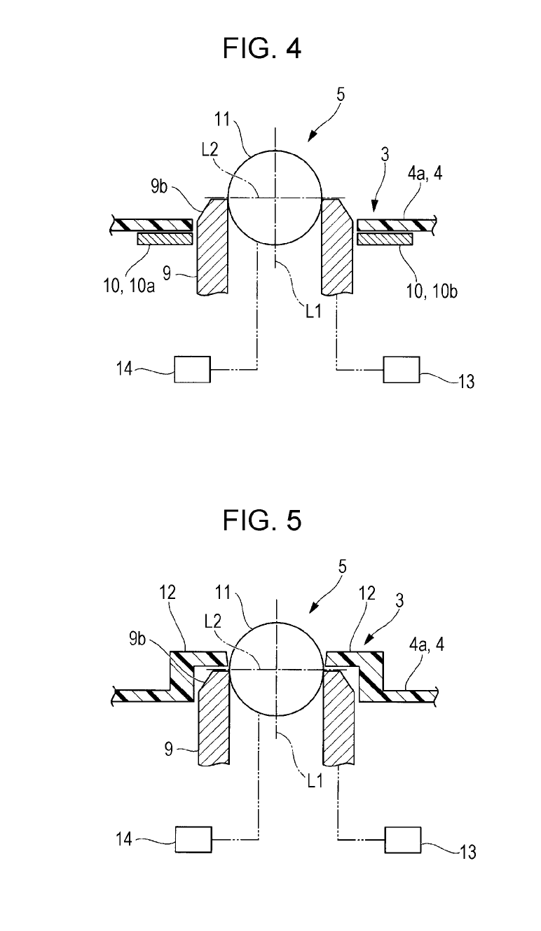

FIG. 3 is a schematic diagram illustrating the configuration of the display apparatus body 5. FIG. 4 is a cross-sectional view illustrating the display apparatus body 5 taken along a line IV-IV in FIG. 3. FIG. 5 is a cross-sectional view illustrating the display apparatus body 5 taken along a line V-V in FIG. 3.

As illustrated in FIGS. 3 to 5, the display apparatus body 5 includes a ring dial 9 disposed in the surface 4a of the spoke 4, a capacitive electrode 10 disposed radially outside the ring dial 9 so as to surround the ring dial 9, and a ball dial 11, which is shaped like a sphere, disposed radially inside the ring dial 9.

The ring dial 9 is used to select a menu item displayed in the uppermost level display area AR1 of the screen G and a menu item displayed in the intermediate level display area AR2. The ring dial 9 is rotatable (in a direction indicated by arrows Y1 in FIG. 3) about an axis L1 perpendicular to the surface 4a of the spoke 4.

The ring dial 9 is disposed such that an axially outer end of the ring dial 9 is exposed from the surface 4a of the spoke 4. The ring dial 9 has a plurality of non-slip grooves 9a extending radially on its exposed surface. The grooves 9a are equally spaced in a circumferential direction.

The ring dial 9 has a sloping surface 9b formed by chamfering an outer circumferential edge of the axially outer end of the ring dial 9. The sloping surface 9b provides smooth or step-free arrangement of the axially outer end of the ring dial 9 and the surface 4a of the spoke 4.

Rotation of the ring dial 9 with the above-described configuration is detected by a first rotation angle detector 13, such as an encoder. The first rotation angle detector 13 outputs a rotation angle signal, indicating a result of detection by the first rotation angle detector 13, to the display ECU 8.

The capacitive electrode 10 disposed around the ring dial 9 is hidden in the spoke 4 such that the capacitive electrode 10 is not exposed from the surface 4a of the spoke 4. The capacitive electrode 10 is disposed so as to be capable of detecting a user's finger touch on the surface 4a of the spoke 4 on the capacitive electrode 10.

The capacitive electrode 10 is configured not to detect the position (coordinates) or the like of a user's finger touch relative to the capacitive electrode 10, but instead to detect only the user's finger touch. The capacitive electrode 10 outputs a touch detection signal, indicating a result of detection by the capacitive electrode 10, to the display ECU 8.

The capacitive electrode 10 includes two segments arranged in the lateral direction (lateral direction in FIG. 3) such that the two segments correspond to the uppermost level display area AR1 and the intermediate level display area AR2 displayed on the screen G. Specifically, the capacitive electrode 10 includes two substantially semicircular electrode segments, namely, a left electrode segment 10a and a right electrode segment 10b arranged symmetrically in the lateral direction.

The left electrode segment 10a is used to select a menu item in the uppermost level display area AR1, namely, the left area displayed on the screen G. The right electrode segment 10b is used to select a menu item in the intermediate level display area AR2, namely, the right area displayed on the screen G. A method of operating the vehicle display apparatus 1 will be described in detail later.

The surface 4a of the spoke 4 includes covering portions 12 each having a substantially L-shaped cross-section such that the covering portions 12 protrude from the surface 4a so as to cover upper and lower parts of the ring dial 9. Specifically, the covering portions 12 are arranged at a boundary between the left electrode segment 10a and the right electrode segment 10b. In other words, the covering portions 12 each serve as a partition between the left electrode segment 10a and the right electrode segment 10b.

The ball dial 11 disposed radially inside the ring dial 9 is used to select a menu item displayed in the lowermost level display area AR3 of the screen G. The ball dial 11 is rotatable (in a direction indicated by an arrow Y2 in FIG. 3) about an axis L2 extending in the lateral direction. Substantially half of the ball dial 11 protrudes from the ring dial 9.

Rotation of the ball dial 11 is detected by a second rotation angle detector 14, such as an encoder. The second rotation angle detector 14 outputs a rotation angle signal, indicating a result of detection by the second rotation angle detector 14, to the display ECU 8.

In addition, the surface 4a of the spoke 4 is provided with various mechanical switches 15 arranged near the display apparatus body 5.

### Method of Operating Vehicle Display Apparatus

The method of operating the vehicle display apparatus 1 will now be described with reference to FIG. 4 and FIGS. 6 to 8.

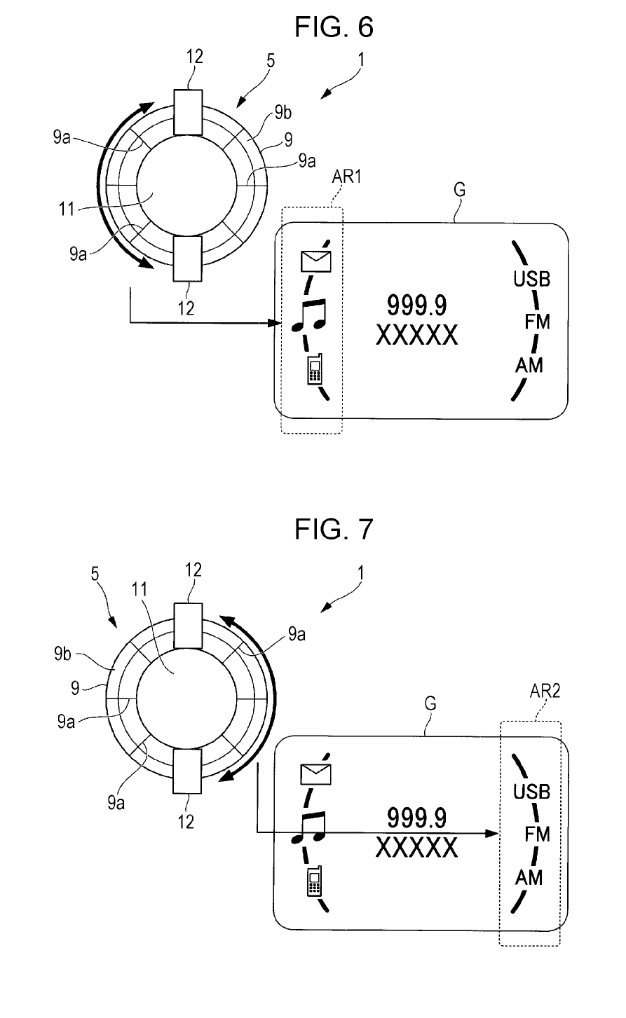

FIGS. 6 to 8 are diagrams explaining the method of operating the vehicle display apparatus 1. In FIGS. 6 to 8, the display apparatus body 5 and the screen G are illustrated side by side for easy understanding of explanation.

First, a menu item is selected from the menu displayed in the uppermost level display area AR1 of the screen G.

In this case, the user touches left part of the ring dial 9 to the left of the covering portions 12 (hereinafter, simply referred to as “left part of the ring dial 9”) and rotates the ring dial 9, as illustrated in FIGS. 4 and 6.

At this time, the user touches the left part of the ring dial 9 and simultaneously touches the spoke 4 radially outside the ring dial 9. Since the ring dial 9 has the sloping surface 9b, the user touches the spoke 4 unconsciously and automatically without feeling uncomfortable when touching the left part of the ring dial 9. Upon touching of the spoke 4 by the user, the left electrode segment 10a detects a user's finger touch on the spoke 4 and outputs a touch detection signal indicating such a detection result to the display ECU 8.

Upon rotation of the ring dial 9, the first rotation angle detector 13 detects an angle of rotation of the ring dial 9 and outputs a rotation angle signal indicating such a detection result to the display ECU 8.

The display ECU 8 causes transition of the menu in the uppermost level display area AR1 of the screen G in accordance with the rotation angle signal output from the first rotation angle detector 13 in response only to receiving the touch detection signal from the left electrode segment 10a. The display ECU 8 then determines, as a selected menu item, a menu item (for example, “music” in FIG. 6) which is stationary in the middle of the uppermost level display area AR1 in the vertical direction.

A menu item is then selected from the menu displayed in the intermediate level display area AR2 of the screen G.

In this case, the user touches right part of the ring dial 9 to the right of the covering portions 12 (hereinafter, simply referred to as “right part of the ring dial 9”) and rotates the ring dial 9 as illustrated in FIGS. 4 and 7.

At this time, the user touches the right part of the ring dial 9 and simultaneously touches the spoke 4 radially outside the ring dial 9. Since the ring dial 9 has the sloping surface 9b, the user touches the spoke 4 unconsciously and automatically without feeling uncomfortable when touching the right part of the ring dial 9 in a manner similar to the above-described touching of the left part of the ring dial 9. Upon touching of the spoke 4 by the user, the right electrode segment 10b detects a user's finger touch on the spoke 4 and outputs a touch detection signal indicating such a detection result to the display ECU 8.

Upon rotation of the ring dial 9, the first rotation angle detector 13 detects an angle of rotation of the ring dial 9 and outputs a rotation angle signal indicating such a detection result to the display ECU 8.

The display ECU 8 causes transition of the menu in the intermediate level display area AR2 of the screen G in accordance with the rotation angle signal output from the first rotation angle detector 13 in response only to receiving the touch detection signal from the right electrode segment 10b. Then, the display ECU 8 determines, as a selected menu item, a menu item (for example, “FM broadcasting” in FIG. 6) which is stationary in the middle of the intermediate level display area AR2 in the vertical direction.

As described above, although the ring dial 9 is a single component, a hierarchy level to be a transition target is changed depending on the capacitive electrode 10 (the left electrode segment 10a or the right electrode segment 10b) detecting a user's finger touch.

A menu item is then selected from the menu displayed in the lowermost level display area AR3 of the screen G.

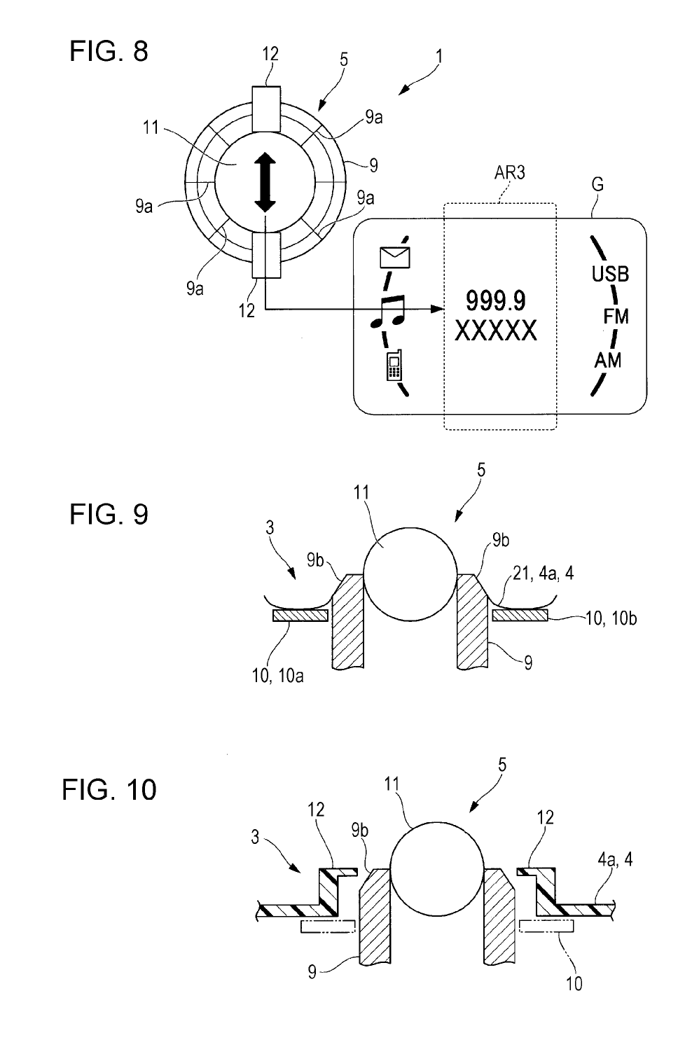

In this case, the user touches and rotates the ball dial 11 as illustrated in FIGS. 4 and 8. The ball dial 11 is rotatable about the axis L2 extending in the lateral direction. Accordingly, the ball dial 11 is rotated in the vertical direction.

Upon rotation of the ball dial 11, the second rotation angle detector 14 detects an angle of rotation of the ball dial 11 and outputs a rotation angle signal indicating such a detection result to the display ECU 8.

The display ECU 8 causes transition of the menu in the lowermost level display area AR3 of the screen G in accordance with the rotation angle signal output from the second rotation angle detector 14. The display ECU 8 then determines, as a selected menu item, a menu item which is stationary in the middle of the lowermost level display area AR3 in the vertical direction. Thus, an operation of the vehicle display apparatus 1 is completed.

In the embodiment, the vehicle display apparatus 1 includes the ring dial 9, the first rotation angle detector 13 that detects an angle of rotation of the ring dial 9, the capacitive electrode 10 (including the left electrode segment 10a and the right electrode segment 10b), and the display panel 6 including the screen G. The vehicle display apparatus 1 is configured to cause transition of the menu in the uppermost level display area AR1 or the intermediate level display area AR2 of the screen G in accordance with a rotation angle signal output from the first rotation angle detector 13 in response only to a touch detection signal output from the capacitive electrode 10. In other words, although the number of ring dials 9 is one, a hierarchy level to be a transition target is changed depending on the capacitive electrode 10 (the left electrode segment 10a or the right electrode segment 10b) detecting a user's finger touch. Consequently, two functions for transition of two hierarchy levels can be arranged in compact form with a simple configuration.

The capacitive electrode 10 is disposed radially outside the ring dial 9 so as to surround the ring dial 9. Accordingly, while the two functions for transition of the two hierarchy levels are arranged in compact form, the ball dial 11 used to cause transition of the menu in the lowermost level display area AR3 can be placed in a space provided radially inside the ring dial 9.

Consequently, three functions (i.e., a function of determining a menu item in the uppermost level display area AR1, a function of determining a menu item in the intermediate level display area AR2, and a function of determining a menu item in the lowermost level display area AR3) can be arranged in a compact space. This enables the vehicle display apparatus 1 to provide ease of operation. Furthermore, this enables the vehicle display apparatus 1 to have a small size, resulting in an increase in design quality of the steering wheel 3.

Since the display apparatus body 5 is disposed on the surface 4a of the spoke 4 of the steering wheel 3, the user can readily operate the vehicle display apparatus 1 without moving his or her hand to the apparatus. This enables the vehicle display apparatus 1 to be user-friendly.

The ring dial 9 has the sloping surface 9b formed by chamfering the outer circumferential edge of the axially outer end of the ring dial 9. The sloping surface 9b provides smooth or step-free arrangement of the axially outer end of the ring dial 9 and the surface 4a of the spoke 4. This can reduce uncomfortable feeling of the user caused upon touching the ring dial 9 and the surface 4a of the spoke 4 at the same time. In addition, when touching the ring dial 9, the user is allowed to touch the surface 4a of the spoke 4 (on the capacitive electrode 10) with a finger unconsciously and automatically without feeling uncomfortable. This enables the vehicle display apparatus 1 to be more user-friendly.

The capacitive electrode 10 is configured not to detect the position (coordinates) or the like of a user's finger touch relative to the capacitive electrode 10, but instead to detect only a user's finger touch. The capacitive electrode 10 can accordingly be achieved with a simple configuration at a low cost, thus resulting in a reduction in manufacturing cost of the vehicle display apparatus 1.

The capacitive electrode 10 includes the two segments arranged in the lateral direction such that the two segments correspond to the uppermost level display area AR1 and the intermediate level display area AR2 displayed on the screen G. This enables the vehicle display apparatus 1 to have a simple configuration and a small size, and provide ease of use.

Arrangement of the covering portions 12 as partitions between the left electrode segment 10a and the right electrode segment 10b of the capacitive electrode 10 prevents the user from accidentally making an effect on the left electrode segment 10a and the right electrode segment 10b.

The display apparatus body 5 is configured such that the left part of the ring dial 9 is operated to select a menu item in the uppermost level display area AR1 displayed on the left of the screen G, the right part of the ring dial 9 is operated to select a menu item in the intermediate level display area AR2 displayed on the right of the screen G, and the ball dial 11 disposed radially inside (or at the center of) the ring dial 9 is operated to select a menu item in the lowermost level display area AR3 displayed in the middle of the screen G in the lateral direction. This arrangement of the components of the display apparatus body 5 can provide an affordance that suggests an intuitive operation of these components.

### First Modification

A first modification of the above-described embodiment will now be described with reference to FIG. 9. In this modification, the same components as those in the above-described embodiment are designated by the same reference numerals and a description of the previously described components is omitted (the same applies to another modification).

FIG. 9 is a cross-sectional view illustrating a display apparatus body 5 in the first modification and corresponds to FIG. 4 described above.

In the first modification, as illustrated in FIG. 9, a surface 4a of a steering wheel 3 (or a spoke 4) has a recess 21 that is radially outside a ring dial 9 so as to surround the ring dial 9. Specifically, the surface 4a of the steering wheel 3 has the recess 21 disposed so as to correspond to a capacitive electrode 10. The recess 21 is shaped so as to smoothly connect to a sloping surface 9b of the ring dial 9.

Such a configuration allows the user to move his or her finger along the recess 21. In other words, the recess 21 functions as a guide that assists the user in moving his or her finger, thus increasing a user's sense of use.

Furthermore, the arrangement of the recess 21 allows the user to be automatically guided to the recess 21, thus enhancing a finger touch detection accuracy of the capacitive electrode 10.

### Second Modification

A second modification of the foregoing embodiment will now be described with reference to FIG. 10.

FIG. 10 is a cross-sectional view illustrating a display apparatus body 5 in the second modification and corresponds to FIG. 5 described above.

In the second modification, as illustrated in FIG. 10, a surface 4a of a steering wheel 3 (or a spoke 4) includes covering portions 12 such that the covering portions 12 are arranged over a capacitive electrode 10 and a ring dial 9 is not covered with the covering portions 12. Specifically, the covering portions 12 do not extend over the ring dial 9. Parts of the ring dial 9 adjacent to the covering portions 12 are exposed.

Such a configuration also allows the covering portions 12 to prevent the user from making an effect on parts of the capacitive electrode 10 adjacent to the covering portions 12. In other words, the user can be prevented from making an effect on a boundary between a left electrode segment 10a and a right electrode segment 10b. Thus, the same advantages as those in the foregoing embodiment can be obtained.

The present disclosure is not limited to the above-described embodiment, and includes various modifications of the foregoing embodiment without departing from the spirit and scope of the present disclosure.

For example, the embodiment has been described with respect to the case where the menu items on the screen G are classified into the three hierarchy levels (the uppermost level, the intermediate level, and the lowermost level) and the capacitive electrode 10 includes the two segments corresponding to two levels (the uppermost and intermediate levels) of the three levels. The number of hierarchy levels on the screen G and the number of segments of the capacitive electrode 10 are not limited to the above-described examples. The number of hierarchy levels on the screen G may be three or more levels. The number of segments of the capacitive electrode 10 may be increased depending on the number of hierarchy levels on the screen G.

The embodiment has been described with respect to the case where the display apparatus body 5 is disposed on the spoke 4 of the steering wheel 3. The display apparatus body 5 may be disposed at any position. For example, the display apparatus body 5 may be disposed on a surface 31a of a center console 31 illustrated in FIG. 1.

The embodiment has been described with respect to the case where the capacitive electrode 10 is configured not to detect the position (coordinates) or the like of a user's finger touch relative to the capacitive electrode 10, but instead to detect only the user's finger touch. The capacitive electrode 10 may have any other configuration. For example, a capacitive electrode capable of detecting, for example, the position (coordinates) of a user's finger touch relative to the capacitive electrode can be used.

What is claimed is:

1. A display apparatus for a vehicle, the apparatus comprising:
a ring-shaped member rotatable about an axis perpendicular to an installation surface in which the ring-shaped member is disposed;
a rotation detector configured to detect the rotation of the ring-shaped member;
a touch detector disposed in a region radially outside the ring-shaped member and adjacent to the ring-shaped member, the touch detector being configured to detect at least a user's touch to the touch detector; and
a display configured to cause transition of screen contents on a screen in response to the detection of the rotation of the ring-shaped member by the rotation detector during the detection of the user's touch by the touch detector.

2. The apparatus according to claim 1, further comprising a steering wheel or a center console, wherein the installation surface is a surface of the steering wheel or the center console.

3. The apparatus according to claim 1, wherein the ring-shaped member has a top surface and a chamfered surface at an outer circumferential edge of the ring-shaped member such that the chamfered surface has an inclined slope from the top surface.

4. The apparatus according to claim 1, wherein the touch detector detects only the user's touch.

5. The apparatus according to claim 1,
wherein the display displays a plurality of selection menus on the screen corresponding to a plurality of hierarchy levels of the screen contents,
wherein the touch detector includes a capacitive electrode to detect the user's touch, and
wherein the capacitive electrode comprises a plurality of capacitive electrode segments corresponding to the hierarchy levels such that one of the capacitive electrode segments can selectively be touched by the user to cause the transition of the screen contents in the corresponding selection menu.

6. The apparatus according to claim 5, further comprising a plurality of covering portions each partly covering the touch detector to partition the touch detector into a plurality of detection regions corresponding to the plurality of capacitive electrode segments.
